(19) United States
(12) Patent Application Publication
(10) Pub. No.: US 2005/0050531 A1
(43) Pub. Date: Mar. 3, 2005

(54) System of benchmarking and method thereof

(76) Inventor: Woo-Hyong Lee, Yongin-si (KR)

Correspondence Address: HARNESS, DICKEY & PIERCE, P.L.C., P.O. BOX 8910, RESTON, VA, 20195, US

(21) Appl. No.: 10/924,938

(22) Filed: Aug. 25, 2004

(30) Foreign Application Priority Data
Aug. 25, 2003 (KR) 2003-58748

(51) Int. Cl. G06F 9/45; G06F 9/44

(52) U.S. Cl. 717/153; 717/118; 717/116

(57) ABSTRACT

A method of benchmarking including generating a first plurality of objects within a benchmark file, generating a second plurality of objects within the benchmark file which do not reference the first plurality of objects, executing the benchmark file, and reporting at least one result of the execution. A system of benchmarking including a processor for generating a first plurality of objects of a first binary tree data structure in a benchmark file for generating a second plurality of objects of a second binary tree data structure without reference to the first binary tree data structure in the benchmark file for executing the benchmark file, and for reporting a result of the execution. A computer program including a computer-readable medium having computer program logic stored thereon for enabling a data processing unit to perform benchmarking, including generating a first plurality of objects of a first binary tree data structure in a benchmark file, generating a second plurality of objects of a second binary tree data structure in the benchmark file, executing the benchmark file, and reporting at least one result of the execution.

This U.S. nonprovisional patent application claims priority under 35 U.S.C. § 119 of Korean Patent Application 2003-58748 filed on Aug. 25, 2003, the entire contents of which are hereby incorporated by reference.

### BACKGROUND OF THE INVENTION

1. Field of the Invention

The present invention, in general, relates to benchmarking, and more particularly, to a method and system for benchmarking garbage collection in a Java virtual machine.

2. Discussion of the Related Art

Java is emerging as a common programming language which may be used on many different types of platforms. Java source code may be compiled to be executed on a Java virtual machine (JVM). A platform equipped with a JVM may execute Java source code. Java source code may be executed by compiling Java source code into Java byte code and then having the JVM execute the compiled Java byte code. Java byte code may be regarded as machine language associated with the JVM. The Java byte codes may be sequences of instructions which may be executed with the JVM.

The JVM may be a virtual computing system installed on a hardware platform with an operating system. The JVM may compile source code into Java byte code which does not need to be re-compiled for execution on other hardware platforms and/or operating systems. Instead, once compiled, Java byte code may be executed on any platform containing a JVM.

The JVM may be classified into four sections: a register, a stack, a garbage-collected heap, and a function field. The function field may be a region where Java byte codes may be permanently stationed. The stack may store parameters for Java byte code commands and/or results of the execution of the Java byte code commands, and may transfer the parameters to the function field. The stack may receive parameter values from the function field, and may retain an invocation state for each function. The garbage-collected heap may be a free storage space containing Java program objects. A memory may be generated from the garbage-collected heap with memory allocation by using an operator “NEW”. The references to Java program objects on the garbage-collected heap may be traced in a Java runtime environment.

In the JVM, Java program objects may be dynamically allocated from the garbage-collected heap and returned to a system. A garbage collection algorithm may determine accessible Java program objects. When it is not possible to access a Java program object, a memory location occupied by the Java program object may return to the system where it may be reused even though it was not de-allocated.

Java program objects may be continuously generated and garbage collection may be performed during the execution of the Java byte code. The Java garbage collection may be one of the most time consuming operations performed in the JVM. Therefore, the performance of the JVM may be affected by garbage collection. While JVMs on different platforms may represent various levels of garbage collection performance, most JVM benchmarks are based on transactions between a client and a central processing unit and/or a server.

Therefore, specifically benchmarking the garbage collection of a JVM may be difficult when benchmarking according to conventional methods. For example, a first JVM on a first platform may have better garbage collecting performance than a second JVM on a second platform, but if the second JVM on the second platform had superior performance overall, one skilled in the art may reach the erroneous conclusion that the second JVM on the second platform also had superior garbage collection performance.

### SUMMARY OF THE INVENTION

An exemplary embodiment of the present invention is a method of benchmarking, including generating a first plurality of objects within a benchmark file, generating a second plurality of objects within the benchmark file which do not reference the first plurality of objects, executing the benchmark file, and reporting at least one result of the execution.

Another exemplary embodiment of the present invention is a system of benchmarking, including a processor for generating a first plurality of objects of a first binary tree data structure in a benchmark file for generating a second plurality of objects of a second binary tree data structure without reference to the first binary tree data structure in the benchmark file, a processor for executing the benchmark file, and for reporting a result of the execution.

Another exemplary embodiment of the present invention is a computer program including a computer-readable medium having computer program logic stored thereon for enabling a data processing unit to perform benchmarking, including generating a first plurality of objects of a first binary tree data structure in a benchmark file, generating a second plurality of objects of a second binary tree data structure in the benchmark file, executing the benchmark file, and reporting at least one result of the execution.

### BRIEF DESCRIPTION OF THE DRAWINGS

The present invention will become more apparent by describing, in detail, exemplary embodiments thereof with reference to the attached drawings, wherein like elements are represented by like reference numerals, which are given by way of illustration only and thus do not limit the exemplary embodiments of the present invention.

FIG. 1 illustrates a benchmarking process of Java garbage collection according to an exemplary embodiment of the present invention.

FIG. 2 illustrates a process of generating a benchmark file.

FIG. 3 illustrates a process of generating the objects of a binary tree data structure according to an exemplary embodiment of the present invention.

FIGS. 4A and 4B illustrate the deletion and regeneration as applied to objects in a binary tree data structure according to an exemplary embodiment of the present invention.

FIGS. 5A and 5B illustrate a mechanism of forming objects nodes of the binary tree data structure according to an exemplary embodiment the present invention.

FIGS. 6A and 6B illustrate the sequence of deleting and regenerating objects in the binary tree data structures shown in FIGS. 5A and 5B, respectively, according to exemplary embodiments of the present invention.

FIG. 7 illustrates a process of generating benchmark files according to another exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings.

In an exemplary embodiment of the present invention, the procedure of workload and benchmarking for garbage collection is exemplarily operable in Java virtual machines (JVMs), but the present invention may be applicable in other programming languages and/or other virtual machines (VMs).

In an exemplary embodiment of the present invention, the execution JVM may include a binary tree data structure. Binary tree data structures are well known in the art and will not be discussed hereafter.

In an exemplary embodiment of the present invention, a maximum depth of a binary tree data structure may be interpreted as a depth of a child node most apart from a root node. For example, assuming that a depth of a root node is 1, two child nodes of the root node may be established to have the deepest depth of 2 wherein no node exists with a depth greater than 2.

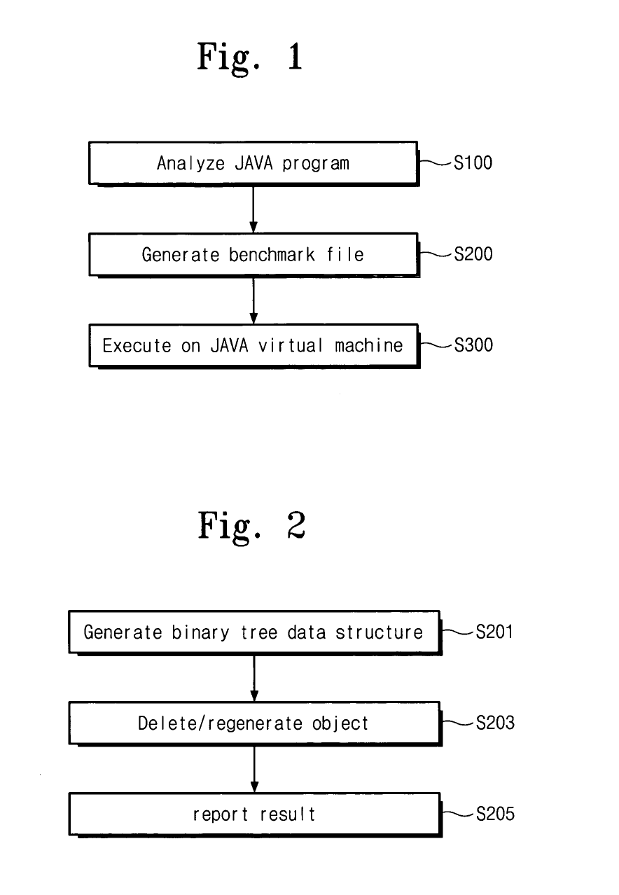

FIG. 1 illustrates a benchmarking process of Java garbage collection according to an exemplary embodiment of the present invention. In S100, a Java program may be analyzed, specifically with regard to an object size, an object lifespan, a size of a largest object, a size of a smallest object, a number of objects, a size of an object frequently generated, and/or other object characteristics.

In S200, a benchmark file may be generated. The benchmark file may contain information about a generation, deletion, and regeneration of an object based on the analysis in S100. Smaller objects may have a shorter lifespan than larger objects because the smaller objects may be more frequently generated and deleted. The process of generating, deleting, and regenerating objects will be described below.

In S300, evaluating a garbage collection of JVM may be accomplished by executing benchmark files on various JVMs, in which a benchmark file which contain a *.java file and/or a *class file. The benchmark file may be converted into Java byte code and thereafter the converted file may be executed on the JVM.

FIG. 2 illustrates a process of generating a benchmark file. In S201, objects may be generated in a binary tree data structure. During object generation in the binary tree data structure, a root node may be generated with a size an average size based on the analysis of S100. The root node may be referred to as a boundary object. The root node may also be representative of an intermediate size between the largest and smallest objects based on the analysis of S100. A child node diverging from the root node, and/or a parent node, may have an intermediate size between the largest and smallest objects based on the analysis of S100. Objects of a size less than or equal to a size of an object of the root node are branched left, while objects larger than the boundary object are branched right. It should be understood that a first node is larger than a second node when a first object in the first node is larger than a second object in the second note. Branching with respect to binary tree data structures is well known in the art and will not be discussed further. In addition, when child nodes diverging from a parent node are less than or equal to their parent node, the child nodes may be branched left from their parent node, while child nodes larger than their parent node are branched right from their parent node. A ratio of the numbers of objects branched left and right from the root node may be adjusted. For example, the size of the root node may be adjusted in order to change the ratio.

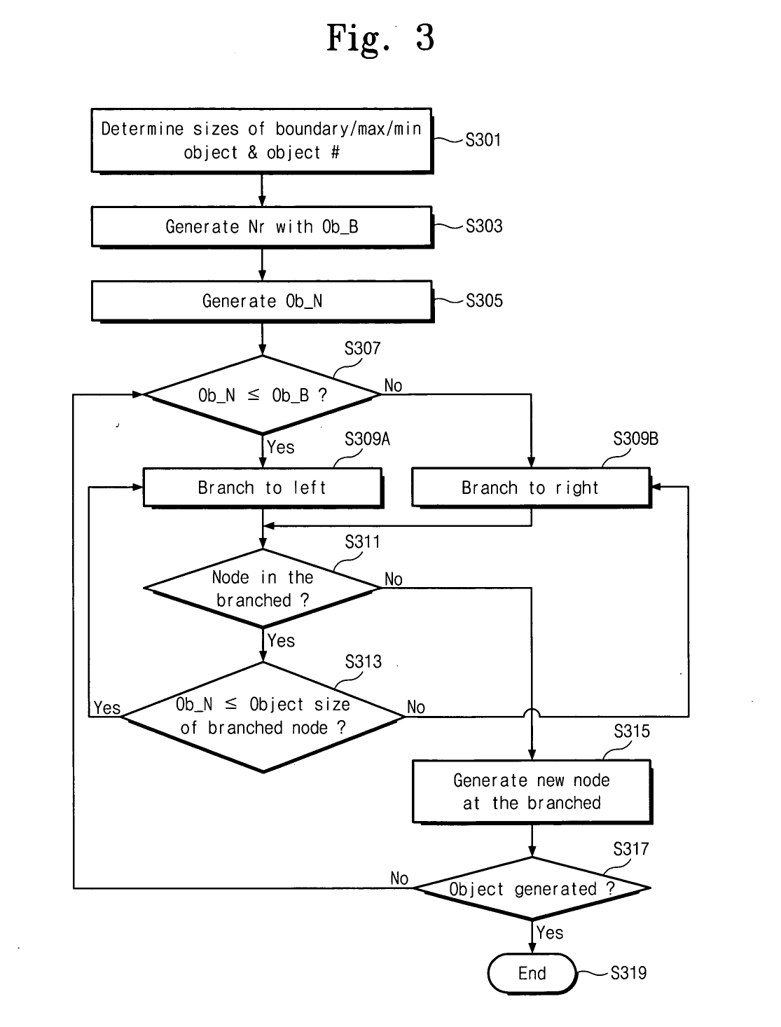

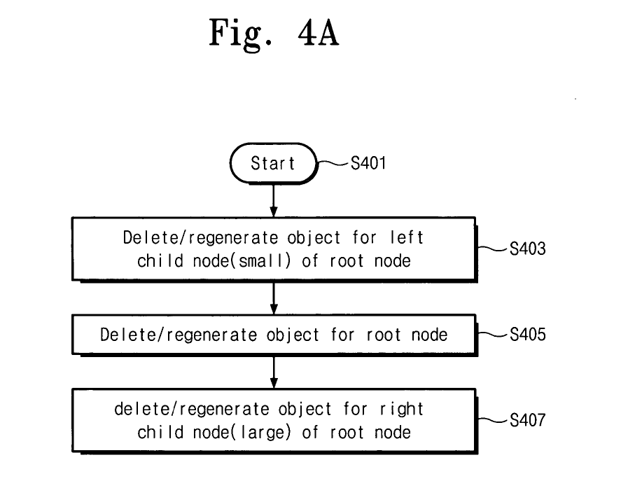

FIG. 3 illustrates a process of generating the objects of a binary tree data structure according to an exemplary embodiment of the present invention.

In S301, the sizes of the boundary object, the largest object, smallest object, and/or the number of objects (i.e., the number of nodes) may be determined.

In S303, the root node may be generated with the boundary object Ob_B. The boundary object Ob_B may be generated with a determined size, forming the root node Nr.

In S305, a new object Ob-N may be generated, wherein Ob-N may have a random object size in a range from the size of the smallest object to the size of the largest object. While adding new objects to the binary tree data structure, a ratio of the numbers of the new objects less than the boundary object to the number of new objects larger than the boundary object may be determined.

In S307, the new objects generated may be compared to the boundary object. From the comparison with the new objects, if one of the new objects, Ob-N, is less than or equal to the boundary object Ob_B, then Ob-N may be branched left from the root node and/or the parent node in S309A. If Ob-N is larger than the boundary object Ob_B, then Ob-N may be branched right from the root node and/or the parent node in S309B.

In S311, a node in the branched side may be analyzed. If there is already an existing node in the branched side, S313 compares the existing node in the branched side with Ob-N. After the comparison with the object of the existing node in the branched side and Ob-N, if the new object Ob_N is less than or equal to the object of the existing node in the branched side, the process may advance to S309A. Otherwise, if Ob-N is larger than the object of the existing node in the branched side, the process may advance to S309B. S311 may only advance to S315 when there is no node in the branched side.

In an exemplary embodiment of the present invention, the process may advance to S315 to generate a new node for the branched side when there is no existing node in the branched side.

In S317, the process may return to S307 when a new object has not been generated in the branched side. The process may advance to S319 from S317 after generating the new object Ob_N in the binary tree data structure.

Referring to FIG. 2, after the binary tree data structure is generated in S201, the new node generated in S317 of FIG. 3 may be deleted and renewal objects may be generated in S203. Deletion and regeneration may first be performed on nodes which branched left from the root node. Deletion and regeneration may then be performed on the root node. Deletion and regeneration may then be performed on nodes which branch right from the deleted root node.

The deletion and regeneration of objects in each branch side may progress from the deepest depth to the shallowest depth. For example, it may be assumed that the binary tree data structure is formed with a depth of “4”. In this example, with respect to the left branch of the root node, the deletion and regeneration may progress in the order of sibling nodes with depth 4, 3, 2, and 1 in sequence. Following the deletion and regeneration of the left branch, the root node with depth 1 may be deleted and regenerated. Following the deletion and regeneration of the root node, the deletion and regeneration of the right branch may progress in the order of sibling nodes with depth 4, 3, 2, and 1 in sequence.

In an exemplary embodiment of the present invention, the order of the deletion and regeneration for nodes may be represented by 4_{L}, 3_{L}, 2_{L}, 1, 4_{R}, 3_{R}, and 2_{R}, wherein the numbers represent the depth of the nodes, and the bottom characters L and R represent the branched sides with respect to the root node, where L represents the left branch and R represents the right branch. Each node may comprise up to two sibling nodes. The deletion and regeneration may be progress from the right branch side to the left branch side as discussed above.

The regeneration may be performed with an object that has the same size as a corresponding deleted object. By regenerating an object of a same size, an identical binary tree data structure may be maintained.

In an exemplary embodiment of the present invention, the deletion and regeneration for an object in a node of a first depth may be executed after completing the deletion and regeneration for another object in a node of a second depth wherein the second depth may be higher than the first depth. In this exemplary embodiment, the deletion and regeneration applied to objects with nodes may be further applied to all of the objects child nodes.

In an exemplary embodiment of the present invention, the deletion and regeneration for nodes of right branch from the root node may be performed after the deletion and regeneration may be applied to the nodes of the left branch from the root node. For example, with the binary tree data structure with a depth 4, wherein the root node depth is 1, the deletion and regeneration applied to objects may be executed in the order of (4_{L}), (4_{L}, 3_{L}), (4_{L}, 3_{L}, 2_{L}), (4_{L}, 3_{L}, 2_{L}, 1), (4_{L}, 3_{L}, 2_{L}, 1, 4_{R}), (4_{L}, 3_{L}, 2_{L}, 1, 4_{R}, 3_{R}), (4_{L}, 3_{L}, 2_{L}, 1, 4_{R}, 3_{R}, 2_{R}) where the deletion and regeneration is applied first to 4_{L} and last to 2_{R}. Therefore, the smaller objects may be more frequently deleted and regenerated, while the larger objects may be less frequently deleted and regenerated. In order to retain the binary tree data structure prior to the deletion and regeneration, the regeneration may generate new child nodes having the same sizes as the deleted child nodes.

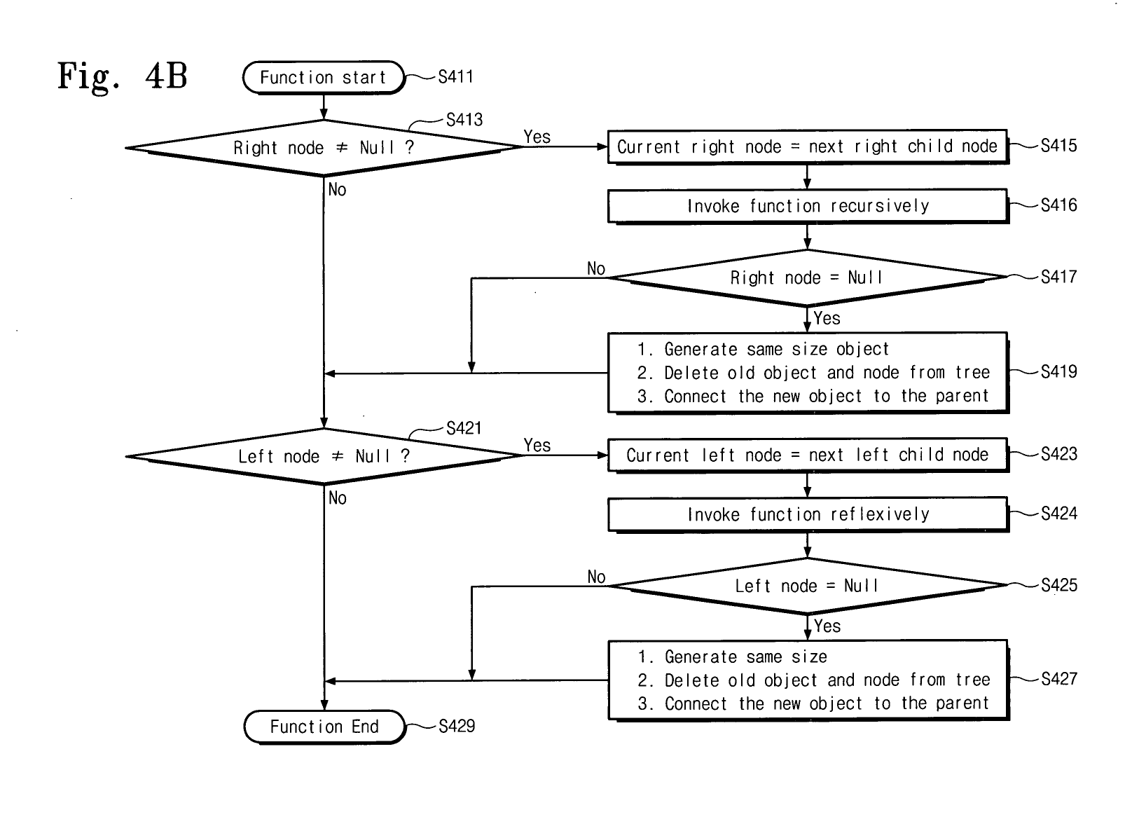

FIGS. 4A and 4B illustrate the deletion and regeneration as applied to objects in a binary tree data structure according to an exemplary embodiment of the present invention.

Referring to FIG. 4A, the deletion and regeneration may be initially applied to nodes on the left branch from the root node in S403. The deletion and regeneration may be applied to the root node in S405. The deletion and regeneration may be applied to nodes on the right branch from the root node in S407.

In order to delete a node and regenerate a new node for the deleted node, binary tree searching may be carried out in advance. In other words, after searching a highest depth node for a present node, deletion and regeneration may be executed in the order from the highest (i.e., deepest) depth node to the present node. A parent node of the present node may be set as a next present node. This process may repeat from the left nodes to the root node, the root node, and then to the right nodes to the root node.

Referring to FIG. 4B, the regeneration begins in S411. In S413, it is determine whether the child node of the right branch has a null state. A node in a null state does not contain an object. If the right child node has a null state, the process may advance to S421 to determine whether the child node of the left branch is in a null state. If the left child node has a null state, the execution of the regeneration may be terminated in S429.

In S413, if a right child node does not have a null state, the process may advance to S415. In S415, the current right child node may be set as the next right child node and the regeneration of FIG. 4B may begin for the next right child node. The process of FIG. 4B may be executed recursively and may repeat until it has been executed for all nodes in the binary tree data structure in S416. After executing the recursive iterations of S416, the process may advance to S417. In S417, it may be determined whether the current right child node has a null state. If the current right child node has a null state, a new object may be generated in the right child node. If the current right child node does not have a null state, the process may advance to S421.

In S421, if a current left child node does not have a null state, the process begins for the next left child node. The process of FIG. 4B may be executed recursively and may repeat until it has been executed for all nodes in the binary tree data structure in S424. After executing the recursive iterations of S424, the process may advance to S423. In S423, the current left child node may be set as the next left child node and then the process of FIG. 4B may advance to S425. In S425, it is determined whether the current left child node has a null state. If the current left child node has a null state, a new object may be generated in the left child node. If not, the process may be terminated in S429.

In an exemplary embodiment of the present invention, the process illustrated in FIG. 4B may be adjusted in its order such that the left child node (or the left sibling node) is deleted and regenerated prior to the right child node (or the right sibling node). This may be accomplished by switching S413 and its associated actions with S421 and its associated actions.

In an exemplary embodiment of the present invention, the binary tree data structure and processes thereof as described above may be executed by a programmer with an ordinary knowledge of computer programming languages.

In an exemplary embodiment of the present invention, a benchmarking program may be associated with an ObjBTree class, an MTBinTree class, and a RanGen class. The ObjBTree class may allow for the generation, deletion, and regeneration of nodes. The MTBinTree class may allow for the generation of a binary tree data structure with the functions provided by the ObjBTree class. The RanGen class may allow the functions for counting random numbers for use with the generation of new objects.

In an exemplary embodiment of the present invention, the ObjBTree class may include an add function, a traverse function, a getDepth function, a getdepth function, and a regenNode function. These functions will be described in detail below.

A function ObjBTree.add(ObjBTree r, Integer n, int objsize) may generate a new node with a new size to be inserted into a binary tree data structure when there is a request for a generation of the new node, wherein a new node larger than the parent node is set to the right sibling node while a node equal to or smaller than the parent node may be set to the left sibling node. A function ObjBTree.traverse(ObjBTree r) may visit all nodes more than one time. A function ObJBTree.getDepth (ObjBTree) may return the depth of a binary tree data structure and may be called by a function ObjBTree.getdepth(ObjBTree r). A function ObjBTree.regenNode (ObjBTree r, int depth) may visit respective nodes to delete their previous objects (i.e., render the previous objects garbage) and may generate new objects within the nodes with the same size to maintain the same tree structure.

An example of the above described exemplary embodiment of the present invention is given below. In this example, source code of the function add ( ) may be arranged as follows.

| | |
|---|---|
| 1. | public static ObjBTree add(ObjB″free r, Integer n, int |

objsize){

| | |
|---|---|
| 2. | if (r = = null) { |
| 3. | r = new ObjBTree( ); |
| 4. | r.left = rright = null; |
| 5. | r.idata = n; |
| 6. | r.sdata = new StringBuffer( ); |
| 7. | r.sdata. setLength(obj size); |
| 8. | } else if (r.idacompareTo(n) < 0) |
| 9. | r.right = add(r.right, n, objsize); |
| 10. | else |
| 11. | r.left = add(r.left, n, objsize); |
| 12. | return r; |
| 13. | } |

The line numbers 1-13 are listed for purpose of reference only, and do not constitute source code.

In the above example source code of the add( ) function, if a current node has a null state as determined in line 2, then the left and right child nodes form a new node with a size (objsize) of the null state. If a current node is not in a null state, an object of the current node may be compared with a new object in line 8. If the new object is larger than an object of the current node, the new object may be formed in a child node by being branched right from the current node (i.e., the parent node). If the new object is less than or equal to an object of the current node, then the new object may be formed in a child node by being branched left from the current node.

An example of the above described exemplary embodiment of the present invention is given below. In this example, source code of the function getDepth ( ) may be arranged as follows.

| | |
|---|---|
| 1. | public void getDepth(ObJBTree r) { |
| 2. | if(r = null) { |
| 3. | curr_depth++; |
| 4. | if (curr_depth > tree_depth) |
| 5. | tree_depth = curr_depth; |
| 6. | getDepth(r.left); |
| 7. | getDepth(r.right); |
| 8. | curr_depth−−; |
| 9. | } |
| 10. | } |

The line numbers 1-10 are listed for purpose of reference only, and do not constitute source code.

A depth of a binary tree data structure may be obtained executing functions getDepth(r.left) and getDepth(r.right) recursively, as shown in lines 6 and 7.

The function regenNode( ) may instruct nodes to delete their previous objects (i.e., render the previous objects garbage) and may generate new objects within the nodes with the same size to maintain the same tree structure. An exemplary source code of the regenNode( ) function may be as follows.

| | |
|---|---|
| 1. | public ObjBTree regenNode(ObjBTree r, int depth) { |
| 2. | ObjBTree tmpleft = null, tmpright = null; |
| 3. | int tmpidata = 0; |
| 4. | curr_depth++; |
| 5. | if(r.right ! =null) { |
| 6. | tmpidata = r.right.idata.intValue( ); |
| 7. | tmpleft = rright.left; |
| 8. | tmpright = r.right.right; |
| 9. | r.right = regenNode(r.right, depth); |
| 10. | if(r.right = = null) { |
| 11. | r.right = new ObjBTree( ); |
| 12. | Integer tmpIdata = new Integer(tmpidata); |
| 13. | r.right.idata = tmpIdata; |
| 14. | r.right.sdata = new StringBuffer( ); |
| 15. | r.reft.sdata.setLenghth(tmpright); |
| 16. | r.right.right = tmpright; |
| 17. | r.right.left = tmpleft; |
| 18. | } |
| 19. | } |
| 20. | if(f.left ! = null) { |
| 21. | tmpidata = r.left.idata.intValue( ); |
| 22. | tmpleft = r.left.left; |
| 23. | tmpright = r.left.right; |
| 24. | r.left = regenNode(r.left, depth); |
| 25. | if(r.left == null) { |
| 26. | r.left = new ObjBTree( ); |
| 27. | Integer tmpIdata = new Integer(tmpidata); |
| 28. | r.left.idata = tmpIdata; |
| 29. | r.left.sdata = new StringBuffer( ); |
| 30. | r.left.sdata.setLength(tmpidata); |
| 31. | r.left.right = tmpright; |
| 32. | r.left.left = tmpleft; |
| 33. | } |
| 34. | } |

The line numbers 1-34 are listed for purpose of reference only, and do not constitute source code.

The function regenNode( ) may contain conditional statements to determine whether the left and right branched nodes are in null states as shown by the lines 5 and 20, respectively. Each conditional statement may also include a statement for executing the regenNode function recursively as shown on the lines 9 and 24, and a nested conditional statement to determine whether or not the left or the right node is in a null state as shown on the lines 10 and 25. If either the left or the right branched node has a null state, a new object may be generated. All of the objects with the deeper depth under a node of a specific depth may be deleted and regenerated.

The MTBinTree class may be associated with an add( ) function, a regenNode( ) function, a getdepth( ) function, and/or a run( ) function. The MTBinTree.add( ) function may generate nodes until a desired number nodes have been generated. The MTBinTree.getdepth( ) function may determine the deepest depth in a generated binary tree data structure. The MTBinTree.regen( ) function may instruct each node of the generated binary tree data structure to delete and regenerate objects therein.

The MTBinTree class may also inherit a thread class to generate a multiplicity of binary tree data structures simultaneously. The MTBinTree.run( ) function may include a control statement for determining the number of objects, the largest object, the smallest object, the boundary object (the root node), and/or the ratio of objects larger than the boundary object to objects smaller than the boundary object, and may execute the functions MTBinTree.add( ), MTBinTree.getdepth( ), and MTBinTree.regen( ) within the control statement.

An exemplary embodiment of the source code of the thread class may be as follows.

| | |
|---|---|
| 1. | class MTBinTree extends Thread { |

| | |
|---|---|
| 2. | protected ObjBTree bnode = null; |
| 3. | protected ObjBTree rnode = null; |
| 4. | protected ObjBTree rnode_1 = null; |
| 5. | protected ObjBTree rnode_1 = null; |
| 6. | protected Integer obji = null |
| 7. | protected int currdepth = 0; |
| 8. | protected static int bmaxsize = 0; |
| 9. | protected static int bnodes = 0; |
| 10. | protected static int bweight = 0; |
| 11. | protected static int bsizebound = 0 |
| 12. | MTBinTree( ) { } |
| 13. | public void add( ) { |
| 14. | bnode = bnode.add (bnode, obji, obji.intValue( ) ); |
| 15. | } |
| 16. | public void regen (ObjBTree node) { |
| 17. | bnode = bnode.regenNode(node, currdepth); |
| 18. | } |
| 19. | public int getdepth(ObJbTree node) { |
| 20. | pub return bnode.getdepth(node); |
| 21. | } |
| 22. | public void run( ) { |
| 23. | int stringsize = 0; |
| 24. | int removedobjs = 0; |
| 25. | int objsize[ ]; |
| 26. | int largeobj = 1 |
| 27. | int smallobj = 1; |
| 28. | int treedepth_1 = 0, treedepth_r = 0; |
| 29. | RanGen r; |
| 30. | JGCW jgcw_bin = new JGCW ( ); |
| 31. | bmaxsize = jgcw_bin.bmaxsize; |
| 32. | bnodes = jgcw_bin.bnodes; |
| 33. | bweight = jgcw_bin,bweight; |
| 34. | bsizebound = jgcw_bin,bsizebound; |
| 35. | objsize = new int[bnodes]; |
| 36. | r = new RanGen(bmaxsize); |
| 37. | for (int i = 0; i<bnodes; i++) { |
| 38. | if ((largeobj*bweight) > (smallobj*(10−bweight))) { |
| 39. | stringsize > bsizebound) { |
| 40. | while (stringsize > bsizebound) { |
| 41. | stringsize = r.RInt( ); |
| 42. | } |
| 43. | objsize[i] = stringsize; |
| 44. | smallobj++; |
| 45. | } |
| 46. | else { |
| 47. | stringsize = r.RInt( ); |
| 48. | while (stringsize > bsizebound) { |
| 49. | stringsize = r.RInt( ); |
| 50. | } |
| 51. | objsize[i] = stringsize; |
| 52. | largeobj++ |
| 53. | } |
| 54. | } |
| 55. | Integer objbound = new Integer(bsizwbound); |
| 56. | obji = objbound; |
| 57. | add( ); |
| 58. | rnode = bnode; |
| 59. | for (int i = 1; i<bonodes; I++) } |
| 60. | Integer objint = new Integer(objsize[i]); |
| 61. | obji = objint; |
| 62. | add( ); |
| 63. | } |
| 64. | jgcw_bin.MemWaterMark( ); |
| 65. | rnode_1 = rnode.left; |
| 66. | rnode_r = rnode.right; |
| 67. | treedepth_1 = getdepth(rnode_l); |
| 68. | treedepth_r = getdepth(rnode_r); |
| 69. | for (int i = treedepth_l; i > 1; i−−) { |
| 70. | currdepth = I; |
| 71. | regen(rnode_1) |
| 72. | jgcw_bin.MemWaterMark( ); |
| 73. | } |
| 74. | for(int i = treedepth_r; i > 1; i−−) { |
| 75. | currdepth = 2; |
| 76. | regen(mode_1); |
| 77. | currdepth = i; |
| 78. | regen(rnode_r); |
| 79. | jbcw_bin.MemWaterMark( ); |
| 80. | } |
| 81. | } |

| | |
|---|---|
| 82. | } |

The line numbers 1-82 are listed for purpose of reference only, and do not constitute source code.

On lines 13-15, the add( ) function is defined. The add( ) function may access ‘add(ObjBTree r, Integer n, int objsize)’ of the ObjBTree class. On the lines 16-18, the regen( ) function is defined. The regen( ) function may access ‘regenNode(ObjBTree r, int depth)’ of the ObjBTree class. On the lines 19-21, the getdepth( ) function is defined. The getdepth( ) function may access ‘getdepth(ObjBTree r, int depth)’ of the ObJBTree class.

The run( ) function may be called on line 22. In the run( ) function, random number may be generated to form a new node with an object on the lines 36-54. The random number may be set to a value between the smallest object size and the largest object size. As the run( ) function is executed, objects with sizes both smaller and larger than the boundary object may be generated with some ratio between the smaller and larger objects.

A size of the boundary object is defined on line 34. The root node may be generated on the lines 55 through 58.

On lines 59-63, additional nodes (e.g., child nodes to the root node) may be generated by using the random number determined by the run( ) function.

On lines 65-68, the child nodes left and right of the root node may be generated. On lines 69-73, the deletion and regeneration may be executed for the left child nodes and the root node, with the ‘for’ loop statement performing an iterative function for multiple deletions and regenerations.

On lines 74-78, the deletion and regeneration for object may be applied to the child node right of the root node. The function ‘regen(rnode_l)’ may be executed to delete and regenerate the objects of the left child nodes on the line 76, and then the function ‘regen(rnode_r) may be executed to delete and regenerate the objects of the right child nodes. Thus, the objects of the child nodes right of the root node may be deleted and regenerated after each of the objects of the child nodes left of the root node may be deleted and regenerated.

Referring again to FIG. 2, in S205, the result of benchmarking may be reported after at least one operation of the deletion and regeneration of objects in the binary tree data structure. The result of benchmarking may include execution times for allocating objects and re-requesting free objects, memory conditions (heap size, allocated spaces, free space, and etc.), and other benchmarking criteria.

In an exemplary embodiment of the present invention, the execution times may be obtained by time stamping both the beginning and fishing times of the program. Time stamping is well known in the art and will not be described further. The difference between the beginning and finishing times of the program may represent the execution time of the program.

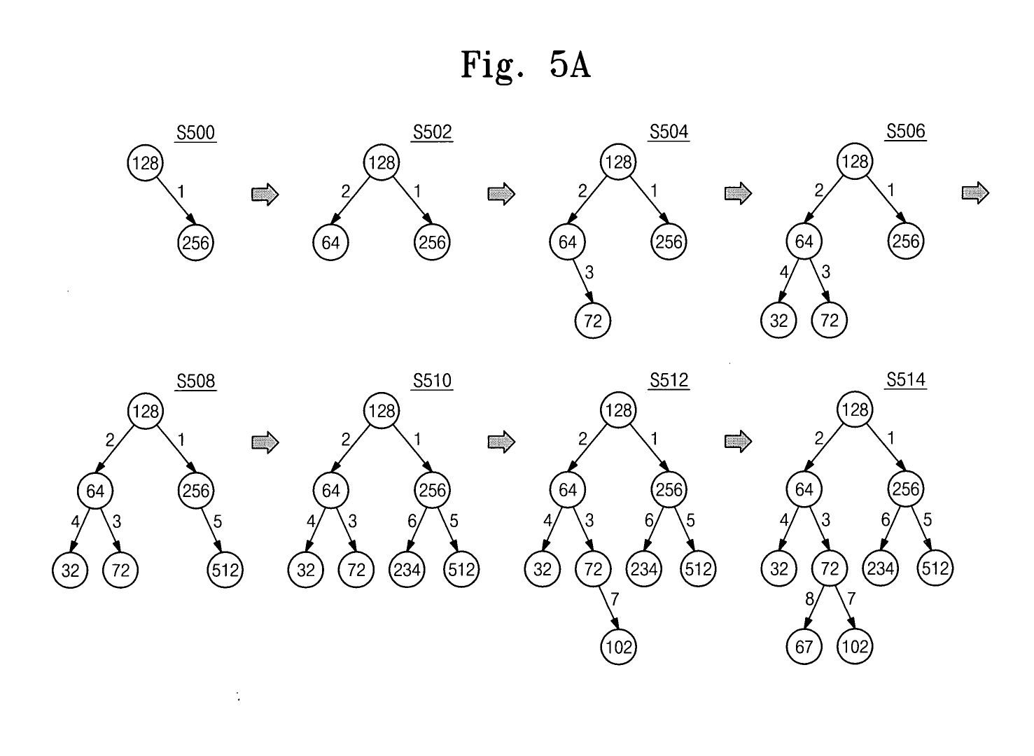

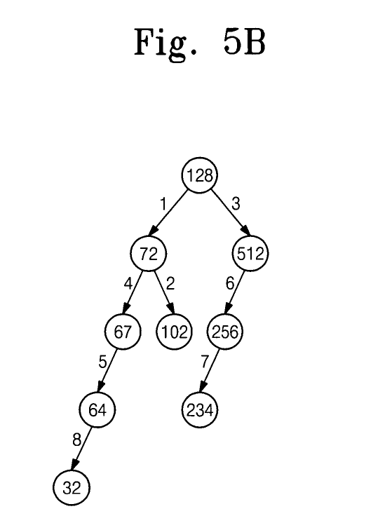

FIGS. 5A and 5B illustrate a mechanism of forming objects nodes of the binary tree data structure according to exemplary embodiments of the present invention. In an example, it may be assumed that the sizes of the boundary object, the largest object, and the least object are 128 bytes, 512 bytes, and 1 bytes, respectively. In an example, the number of the objects may be 9, including the boundary object. With the exception of the boundary object, additional objects may be generated at random.

Referring FIG. 5A, the objects generated in the order of 256, 64, 72, 30, 512, 234, 102, and 67. Referring to FIG. 5B, the objects may be generated in the order of 71, 102, 512, 67, 74, 256, 234, and 32.

In an exemplary embodiment of the present invention, referring to FIG. 5A, the root node may be formed for the boundary object with a size of 128 bytes. The first object generated with 256 bytes is larger than the boundary object with a size of 128 bytes, and it is branched right from the root node (i.e., the boundary object) and forms a first right child node with a depth of 2, and a path 1 as illustrated in S500. The second object generated with 64 bytes is smaller than the boundary object of the root node, and it is branched left from the root node and forms a left child node with a depth of 2, and a path 2 as illustrated in S502. The third object is generated with 72 bytes and is smaller than the boundary object of the root node, and it is branched left from the root node and then further branched right from the left child node of 64 bytes (path 3), as it is smaller than the boundary object (128 bytes) of the root node but larger than the second object (64 bytes), forming a right child node with a depth of 3.

Similar to the process described above with respect to the first, second and third objects, additional objects are added in S506, S508, S510, S512, and S514. The resultant binary tree data structure of S514 contains each inserted object.

In another exemplary embodiment of the present invention, referring to FIG. 5B, the same objects have been inserted into the illustrated binary tree data structure as FIG. 5A, only in a different order, thus creating a different binary tree data structure. With the generation order different from that of FIG. 5A, the first object generated with 72 bytes is branched left from the root node and then forms a left child node with a depth of 2 (path 1). Similar to the process described above with respect to the first object, additional objects are added to the binary tree data structure of FIG. 5B. The resultant binary tree data structure of FIG. 5B may contain each object inserted into the resultant binary tree data structure.

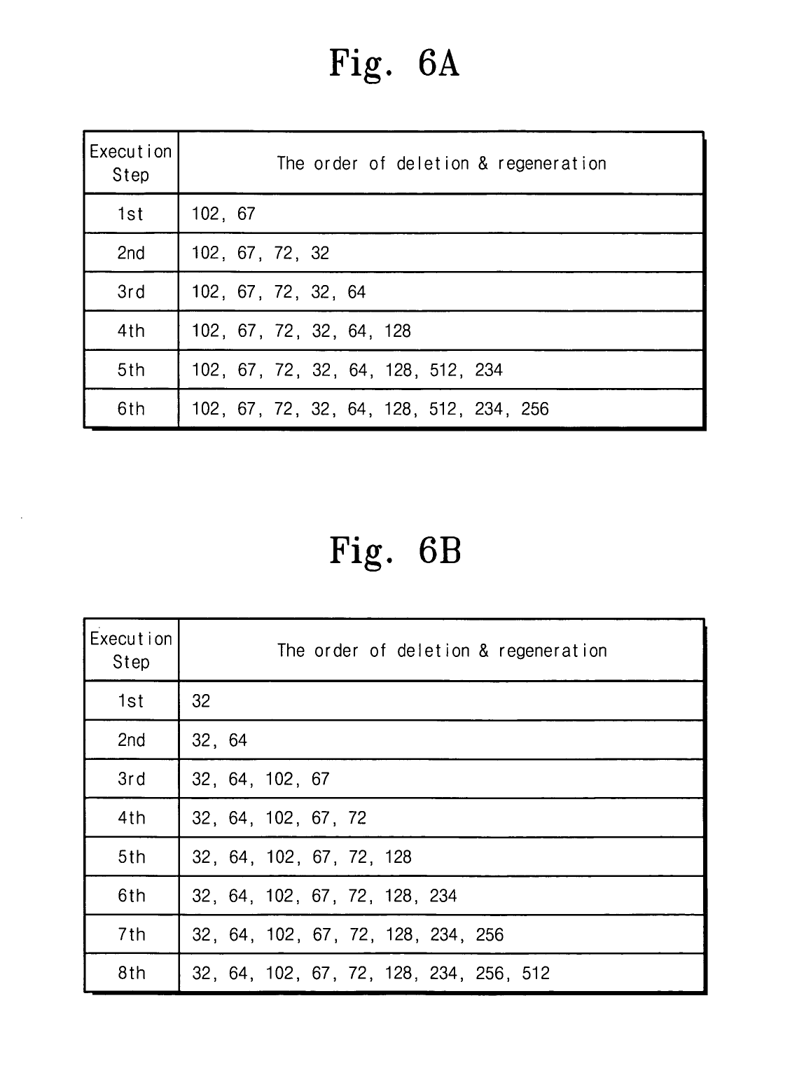

FIGS. 6A and 6B illustrate the sequence of deleting and regenerating objects in the binary tree data structures shown in FIGS. 5A and 5B, respectively, according to exemplary embodiments of the present invention. As described above, the deletion and regeneration of objects proceeds in the order of the left branched nodes from the root node, the root node, and the right branched nodes from the root node, and further from the highest depth to the lowest depth. As shown, an object is deleted and then regenerated.

Referring to FIG. 6A, which corresponds to the binary tree data structure of S514 in FIG. 5A, the objects of 102 bytes and 67 bytes, having the highest depth 4 in the binary tree data structure, among the left child nodes (herein, 102, 67, 72, and 32 bytes) of the root node (128 Byte), may be deleted and regenerated in order. The right sibling nodes (e.g., 102 Byte) may be deleted and regenerated earlier than the left sibling nodes (e.g., 67 Byte), or vice versa. As shown in FIG. 6A. 102 may be deleted first in the 1^{st} execution, and 67 may be deleted second in the 1^{st} execution.

In the 2^{nd} execution, for depth 3 of a left child node, the objects deleted and generated in the previous execution (1^{st}) (i.e., at depth 4) may again be deleted and regenerated. Then, the objects 72 bytes and 32 bytes, having a depth 3, may be deleted and regenerated.

The 3^{rd} execution, for depth 2 of the left child node, may be executed similar to the 2^{nd} execution. In the 3^{rd} execution, the objects deleted and generated in the previous execution (2^{nd} execution) may again be deleted and regenerated, and then the object with 64 bytes and a depth 2 may be deleted and regenerated. The 3^{rd} execution may complete the deletion and regeneration of the original left branch of the original binary tree data structure.

The 4^{th} execution may be executed similar to the previous executions. The objects deleted and regenerated in the previous execution (3^{rd} execution) may again be deleted and regenerated, and then the object with 128 bytes (i.e., the boundary object) of the root node may be deleted and regenerated. The 4^{th} execution may complete the deletion and regeneration of the original root node of the original binary tree data structure.

In turn, objects of the right child node to the root node may then be deleted and regenerated. The 5^{th} execution may be executed similar to the previous executions. In the 5^{th} execution, for depth 2 of the right child node, the objects, deleted and generated in the previous execution (4^{th} execution) may again be deleted and regenerated, and then the objects with 512 and 234 bytes, respectively, and with depth 2, may be deleted and regenerated.

The 6^{th} execution may be executed similar to the previous executions. In the 6^{th} execution, for depth 3 of the right child node, the objects deleted and generated in the previous execution (5ⁿ execution) may again be deleted and regenerated, and then the objects with 256 bytes at depth 3 may be deleted and regenerated. The 6^{th} execution may complete the deletion and regeneration of the original right branch of the original binary tree data structure.

Referring to FIG. 6B, which may correspond to the binary tree data structure illustrated in FIG. 5B, illustrates the process of deletion and regeneration. However, as previous indicated, the deletion and regeneration may first be executed on the right sibling node instead of the left sibling node. FIG. 6B, in contrast to FIG. 6A, illustrates an order of deletion and regeneration first executed on the right sibling node instead of the left sibling node.

Referring to FIG. 6B, in a 1^{st} execution, the object of the left child node with the deepest depth 5, 32 bytes, may be deleted and regenerated.

In a 2^{nd} execution, the object of 64 byte in the left child node with depth 4 may be deleted and regenerated after object 32 bytes of the previous execution is again deleted and regenerated.

The 3^{rd} execution may be executed similar to the previous execution. It should be noted that the object 102 may be deleted and regenerated before object 67. If the deletion and regeneration process were executed similar to FIG. 6A, the object 67 would be deleted before the object 102, as object 102 is the right sibling and object 67 is the left sibling.

The 4^{th} execution may be executed similar to the previous executions. The 4^{th} execution may complete the deletion and regeneration of the original left branch of the original binary tree data structure.

The 5^{th} execution may be executed similar to the previous executions. The 5^{th} execution may complete the deletion and regeneration of the original root node of the original binary tree data structure.

The 6^{th} execution may be executed similar to the previous executions.

The 7^{th} execution may be executed similar to the previous executions. The 7^{th} execution may complete the deletion and regeneration of the original left branch of the original binary tree data structure.

The 8^{th} execution may be executed similar to the previous executions. The 8^{th} execution may complete the deletion and regeneration of the original right branch of the original binary tree data structure.

As illustrated by FIGS. 6A and 6B, the smaller objects (of the left child nodes) may be more frequently deleted and regenerated as compared to the larger objects (of the right child nodes).

In an exemplary embodiment of the present invention, the JVM may include a multi-thread application. The multi-thread application may enable the binary tree data structure to have a plurality of instantiations with a plurality of formations. In this exemplary embodiment of the present invention, the multi-thread application may form a survival object. Survival objects may not be deleted when the program is running. Boundary objects in a thread of the multi-thread application may be identical or different boundary objects of another thread of the multi-thread application.

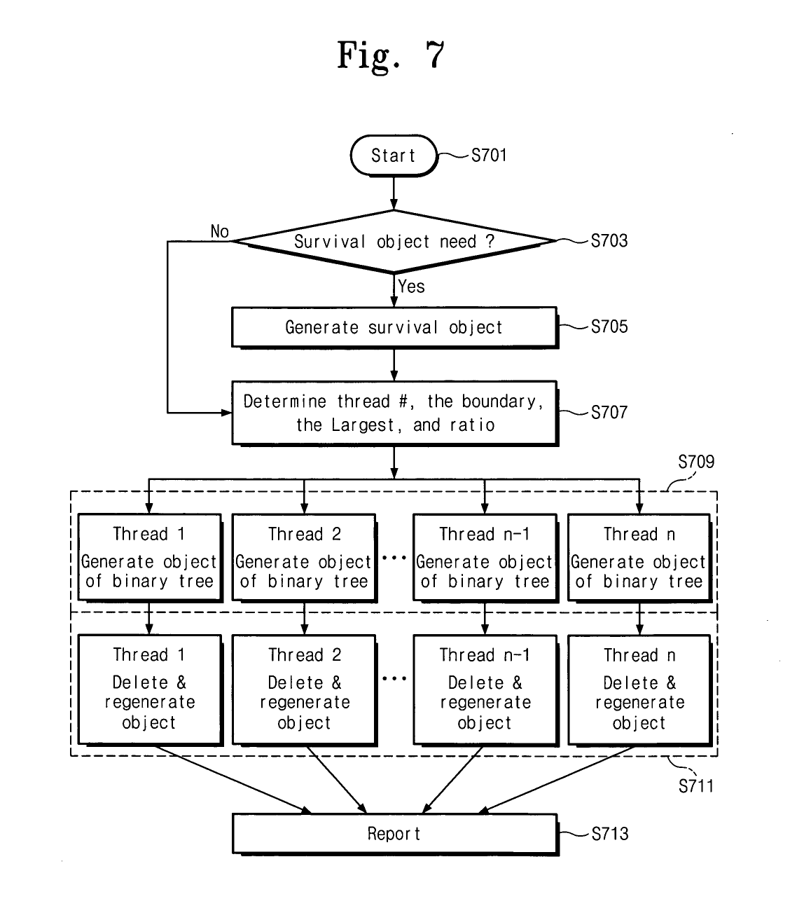

FIG. 7 illustrates a process of generating benchmark files according to another exemplary embodiment of the present invention.

The process may be initiated in S701, and advances to S703. In S703, it may be determined whether there is a need for generating a survival object. The survival object may continuously occupy a memory without being deleted during an execution of a program. If there is determined to be a need for the survival object in S703, the survival object may be generated in S705. The survival object may have various data structures which may include link lists, arrays, a binary tree data structure, and/or other data structures. The JVM may use the survival object multiple times during the execution of a multi-thread application.

In S707, the process may determine the number of threads, the boundary object, the largest object, and/or the ratio between the generated objects larger than the boundary object and generated objects smaller than the boundary object. The boundary object may be determined to meet some criteria. Objects other than the boundary objects may be determined randomly.

A plurality of threads may be formed in S709. Each thread may comprise a binary tree data structure which may comprise objects.

In S711, the deletion and regeneration for objects may be executed in each thread. This process of deletion and regeneration may be similar to the process of deletion and regeneration described with respect to FIG. 6A or 6B.

At least one result of the execution of the threads may be reported in S713.

According to the exemplary embodiments of the present invention as described above, the present invention may provide a garbage collection benchmark.

The exemplary embodiments of the present invention being thus described, it will be obvious that the same may be varied in many ways. For example, the example source code and function names may be changed significantly while remaining within the scope of the invention. Further, the process of branching has been described first branching left and then branching right, however this process could easily be reversed. For example, objects less than a boundary object could branch to the right and objects greater than a boundary object could branch to the left.

For example, the functional blocks in FIGS. 1-7 describing the exemplary apparatus and methods may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations or functions. The computer executable program(s) may also be provided as part of externally supplied propagated signal(s).

Further, such programs, when recorded on computer-readable storage media, may be readily stored and distributed. The storage medium, as it is read by a computer, may thus enable exemplary embodiments of the benchmarking system and method described above.

Such variations are not to be regarded as departure from the spirit and scope of the exemplary embodiments of the present invention, and all such modifications as would be obvious to one skilled in the art are intended to be included within the scope of the following claims.

1. A method of benchmarking, comprising:
generating a first plurality of objects within a benchmark file;
deleting the first plurality of objects and regenerating a second plurality of objects in place of the deleted first plurality of objects;
executing the benchmark file; and
reporting at least one result of the execution.

2. The method of claim 1, wherein the first plurality of objects are generated in a binary tree data structure based on a size of at least one object of the first plurality of objects and the second plurality of objects are regenerated in the binary tree data structure based on the first plurality of objects.

3. The method of claim 1, wherein executing the benchmark file is performed in a Java virtual machine.

4. The method of claim 2, further comprising generating additional binary tree data structures with a same number of nodes but different binary tree data structures than the binary tree data structure with the first plurality of objects.

5. The method of claim 2, wherein generating the first plurality of objects further comprises:
branching two potential descendant nodes from a first parent node,
wherein an object with a size being less than or equal to an object of the first parent node is branched to a left potential descendant node, and an object with a size being greater than the object of the first parent node is branched to a right potential descendant node, and
wherein a second parent node not including a third parent node is a root node.

6. The method of claim 5, wherein a size of a regenerated second object is the same as a corresponding deleted first object, and wherein deleting the first plurality of objects and regenerating the second plurality of objects is carried out in the order of a descendant node branching left from the root node, the root node and a descendant node branching right from the root node.

7. The method of claim 6, wherein deleting the first plurality of objects and regenerating the second plurality of objects in a current node is carried out in an order beginning with a deepest node and ending with the current node.

8. The method of claim 6, further comprising generating additional binary tree data structures with a same number of nodes but different binary tree data structures than the binary tree data structure with the first plurality of objects.

9. The method of claim 2, wherein generating the first plurality of objects in the binary tree data structure comprises:
generating a root node for the binary tree data structure;
generating random numbers for the first plurality of objects;
branching two potential descendant nodes from the root node by using the random numbers to generate the binary tree data structure;
wherein a random number being less than or equal to a size of the root node is branched to a left potential descendant node, and a random number being greater than the size of the root node is branched to a right potential descendant node, and a child node being less than or equal to a parent node is branched to a left of the patent node, and a child node being greater than the parent node is branched to a right of the parent node.

10. The method of claim 2, further comprising generating survival objects prior to generating the benchmark file.

11. The method of claim 1, wherein the at least one result indicates at least one of sizes of allocated memory, sizes of unallocated memory, and time elapsed during the benchmark file execution.

12. The method of claim 4, further comprising analyzing object characteristics in real object oriented programs before generating the benchmark file, wherein the object characteristics comprise at least one of the number of objects, the average object size, the size of the objects frequently generated, the object with the largest size, and the object with the smallest size.

13. The method of claim 12, wherein a size of a root node is the average object size, and the size and number of the first plurality objects are determined based on the result of analyzing the object characteristics.

14. A method of benchmarking, comprising:
generating a first plurality of objects in a binary tree data structure within a benchmark file;
deleting the first plurality of objects and regenerating a second plurality of objects in place of the deleted first plurality of objects;
executing the benchmark file; and
reporting at least one result of the execution.

15. The method of claim 14, wherein generating the first plurality of objects further comprises:
branching two potential descendant nodes from a first parent node,
wherein an object with a size being less than or equal to an object of the first parent node is branched to a left potential descendant node, and an object with a size being greater than the object of the first parent node is branched to a right potential descendant node, and
wherein a second parent node not including parent node is a root node.

16. The method of claim 15, wherein a size of a regenerated second object is the same as corresponding deleted first object, and wherein deleting the first plurality of objects and regenerating the second plurality of objects is carried out in an order of a descendant node branching left from the root node, the root node and a descendant node branching right from the root node.

17. The method of claim 16, wherein deleting the first plurality of objects and regenerating the second plurality of objects in a current node is carried out in an order beginning with a deepest node and ending with the current node.

18. The method of claim 16, further comprising generating additional binary tree data structures with a same number of nodes but different binary tree data structures than the binary tree data structure with the first plurality of objects.

19. The method of claim 14, further comprising analyzing object characteristics in real object oriented programs before generating the benchmark file, wherein the object characteristics comprise at least one of the number of objects, the average object size, the size of the objects frequently generated, the object with the largest size, and the object with the smallest size.

20. The method of claim 19, wherein a size of a root node is the average object size, and the size and number of the first plurality objects are determined based on the result of analyzing the object characteristics.

21. A system of benchmarking, comprising:
a processor for generating a first plurality of objects of a binary tree data structure in a benchmark file, for deleting the first plurality of object and regenerating a second plurality of objects in the binary tree data structure, for executing the benchmark file, and for reporting a result of the execution.

22. The system of claim 21, wherein said processor further comprises:
branching two potential descendant nodes from a first parent node,
wherein an object with a size being less than or equal to an object of the first parent node is branched to a left potential descendant node, and an object with a size being greater than the object of the first parent node is branched to a right potential descendant node, and
wherein a second parent node not including a third parent node is a root node.

23. The system of claim 22, wherein each of the regenerated second plurality of objects are the same size as each of the first plurality of objects, and wherein the deleting and regenerating is carried out in an order of a descendant node branching left from the root node, the root node and a descendant node branching right from the root node.

24. The system of claim 23, wherein deleting the first plurality of objects and regenerating the second plurality of objects in a current node is carried out in an order beginning with a deepest node and ending with the current node.

25. The system of claim 21, wherein the processor generates additional binary tree data structures with a same number of nodes but different binary tree data structures than the binary tree data structure by the first plurality of objects.

26. The system of claim 21, wherein the processor generates survival objects prior to generating the benchmark file.

27. A computer program comprising a computer-readable medium having computer program logic stored thereon for enabling a data processing unit to perform benchmarking, comprising:
generating a first plurality of objects in a binary tree data structure within a benchmark file;
deleting the first plurality of objects and regenerating a second plurality of objects in place of the deleted first plurality of objects;
executing the benchmark file; and
reporting at least one result of the execution.

28. The computer program of claim 27, wherein the at least one result indicates garbage collection performance of the benchmark file.

29. The computer program of claim 27, wherein executing the benchmark file is performed in a Java virtual machine.

30. The computer program of claim 27, wherein each first parent node in the binary tree data structure includes two potential descendant nodes and a second parent node not including a third parent node is a root node,
wherein one of the two potential descendant nodes includes a first object with a size less than or equal to a second object of the first parent node is branched left from the first parent node, and the other of the two potential descendant nodes including a third object with a size greater than the object of the parent node is branched right from the parent node,
wherein deleting the first plurality of objects and regenerating the second plurality of objects is carried out in an order of a descendant node branching left from the root node, the root node and a descendant node branching right from the root node.

31. The method of claim 30, wherein deleting the first plurality of objects and regenerating the second plurality of objects in a current node is carried out in an order beginning with a deepest node and ending with the current node.

32. A system of benchmarking for performing the method of claim 1.

33. A computer program for performing the method of claim 1.

34. A system of benchmarking for performing the method of claim 14.

35. A computer program for performing the method of claim 14.
